(19) United States
(12) Patent Application Publication
(10) Pub. No.: US 2024/0072285 A1
(43) Pub. Date: Feb. 29, 2024

(54) ENERGY STORING ELECTRICITY GENERATOR

(71) Applicant: Ohmium International, Inc., Incline Village, NV (US)

(72) Inventors: Arne Ballantine, Incline Village, NV (US); Chokkalingam Karuppaiah, Fremont, CA (US); Valeta Massey, Woodside, CA (US)

(21) Appl. No.: 18/239,540

(22) Filed: Aug. 29, 2023

Related U.S. Application Data
(60) Provisional application No. 63/401,750, filed on Aug. 29, 2022.
(60) Provisional application No. 63/401,751, filed on Aug. 29, 2022.
(60) Provisional application No. 63/401,752, filed on Aug. 29, 2022.
(60) Provisional application No. 63/416,090, filed on Oct. 14, 2022.

(51) Int. Cl. H01M 8/0656; H01M 8/04007; H01M 8/04082; H01M 8/04119; H01M 8/0662

(52) U.S. Cl. CPC H01M 8/0656; H01M 8/04074; H01M 8/04126; H01M 8/04201; H01M 8/0662

(57) ABSTRACT

The present disclosure provides systems and methods for generating and storing hydrogen and electricity. The systems generally include an electrolyzer stack, a fuel cell stack operably connected to the electrolyzer stack, and a hydrogen recirculation stack operably connected to the electrolyzer stack and to the fuel cell stack.

### CROSS-REFERENCE TO RELATED APPLICATIONS

This application claims priority to U.S. Provisional Application No. 63/401,750 entitled “ENERGY STORING ELECTRICITY GENERATOR”, filed Aug. 29, 2022; U.S. Provisional Application No. 63/401,751 entitled “ENERGY STORING ELECTRICITY GENERATOR WITH CASCADING RECIRCULATION PUMPS”, filed Aug. 29, 2022; U.S. Provisional Application No. 63/401,752 entitled “ENERGY STORING ELECTRICITY GENERATOR WITH COMPLEX MOLECULE GENERATION” filed Aug. 29, 2022; and to U.S. Provisional Application No. 63/416,090 entitled “ENERGY STORING ELECTRICITY GENERATOR”, filed Oct. 14, 2022, the entire contents of each of which are incorporated by reference herein in their entirety.

### FIELD OF THE DISCLOSURE

The present disclosure is related to systems and methods for generating and storing hydrogen and electricity.

### BACKGROUND

Global warming, greenhouse gas effect, climate change and associated power instabilities define the requirement for power generators to become more efficient and also more resilient in that they are able to power their respective loads during periods of days of input energy stability.

Inventions of the prior art have utilized short term types of energy storage (such as lead acid or lithium-ion batteries). Other inventions have utilized the utility grid as a means of power generation in hybrid with batteries. Still others have utilized a hybrid model where distributed fuel generators with a delivered fuel source are utilized.

What is needed is a system for generating and storing energy that produces few greenhouse gas emissions.

### SUMMARY

Provided herein are systems for generating and storing energy. The systems generally comprise an electrolyzer stack for generating hydrogen, a fuel cell stack operably connected to the electrolyzer stack for converting the generated hydrogen into electricity, and a hydrogen recirculation stack operably connected to the fuel cell stack and to the electrolyzer stack. In some embodiments, the system comprises a plurality of hydrogen recirculation stacks arranged in a cascade. In some embodiments, the hydrogen utilization of the system is 95% or greater.

In some embodiments, the electrolyzer stack comprises a membrane electrolyte. In some examples, the membrane electrolyte comprises a proton exchange membrane, an anion exchange membrane, or a combination thereof. In some additional embodiments, the proton exchange membrane comprises sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or a combination thereof. In a preferred example, the proton exchange membrane comprises a sulfonated tetrafluoroethylene-based fluoropolymer-copolymer having a formula C₇HF₁₃O₅S·C₂F₄. In some additional embodiments, the anion exchange membrane comprises imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, or a combination thereof.

In some embodiments, the electrolyzer stack is electrically connectable to an intermittent energy input. In some additional embodiments, the intermittent energy input is selected from the group consisting of photovoltaics, wind, hydroelectric, or a combination thereof. In some examples, the electrolyzer stack is electrically connected to an intermittent energy input. In some embodiments, the electrolyzer stack is fluidly connectable to a water source. In still further embodiments, the electrolyzer stack is fluidly connectable to a hydrogen storage system.

In some embodiments, the fuel cell stack comprises a membrane electrolyte. In some embodiments, the membrane electrolyte comprises a sulfonated tetrafluoroethylene-based fluoropolymer-copolymer having a formula C₇HF₁₃O₅S·C₂F₄. In some embodiments, the fuel cell stack is fluidly connectable to a hydrogen storage system.

In some embodiments, the hydrogen recirculation stack comprises an electrochemical hydrogen pump. In some embodiments, the electrochemical hydrogen pump comprises a membrane electrolyte. In some embodiments, the membrane electrolyte comprises a proton exchange membrane. In still further embodiments, the membrane electrolyte comprises a sulfonated tetrafluoroethylene-based fluoropolymer-copolymer having a formula C₇HF₁₃O₅S·C₂F₄. In some additional embodiments, the hydrogen recirculation stack is fluidly connected to the electrolyzer stack. In still further embodiments, the hydrogen recirculation stack is fluidly connectable to a hydrogen storage system.

In some embodiments, the hydrogen recirculation stack comprises an inlet that is operable to receive wet hydrogen and/or dry hydrogen. In some additional embodiments the hydrogen recirculation stack comprises an outlet comprising purified hydrogen. Preferably, the outlet of the hydrogen recirculation stack is fluidly connected an inlet of the fuel cell stack. In still other preferred embodiments, the fuel cell stack comprises an outlet comprising hydrogen gas that is fluidly connected to the inlet of the hydrogen recirculation stack.

In some embodiments, the system further comprises a venturi device. Preferably, the venturi device is fluidly connected to the hydrogen recirculation stack and to the fuel cell stack.

In some embodiments, the system further comprises power electronics. In some embodiments, the power electronics are electrically connectable to at least one of a DC energy input, an AC energy input, or a combination thereof. In some examples, the power electronics are electrically connected to at least one of a DC energy input, an AC energy input, or a combination thereof. In further embodiments, the power electronics are electrically connectable to at least one of a DC energy load, an AC energy load, or a combination thereof. In some examples, the power electronics are electrically connected to at least one of a DC energy load, an AC energy load, or a combination thereof.

In some embodiments, the system further comprises a heat exchanger. In some embodiments, the heat exchanger is operably connected to at least one of the electrolyzer stack, the fuel cell stack, and the hydrogen recirculation stack. In some examples, the heat exchanger is thermally connected to at least one of the electrolyzer stack, the fuel cell stack, and the hydrogen recirculation stack. In some additional embodiments, the heat exchanger is operable to deliver heat from the electrolyzer stack, the fuel cell stack, and/or the hydrogen recirculation stack to a heating load. In further embodiments, the heat exchanger is operably connectable to a heat source. In some examples, the heat exchanger is operably connected to a heat source. In still further examples, the heat exchanger is thermally connected to a heat source. In further embodiments, the heat exchanger is operably connected to a cooling source. In some examples, the heat exchanger is thermally connected to a cooling source.

In some embodiments, the system further comprises a water source. Preferably, the electrolyzer stack is fluidly connectable to the water source. In some examples, the electrolyzer stack is fluidly connected to the water source.

In some embodiments, the system further comprises a dryer. In some embodiments, the dryer is selected from the group consisting of a pressure swing adsorption (PSA) system, a temperature swing adsorption (TSA) system, a hybrid PSA-TSA system, or a membrane purifier. In additional embodiments, the dryer comprises an inlet operable to receive wet hydrogen and an outlet operable to deliver dry hydrogen. In still further embodiments, the dryer is fluidly connected to the electrolyzer stack and to the fuel cell stack.

In some embodiments, the system further comprises a humidifier. In some embodiments, the humidifier is fluidly connected to the fuel cell stack.

Further provided herein is a method of generating and storing energy. The method comprises generating hydrogen in an electrolyzer stack; combining the hydrogen with oxygen in a fuel cell stack, resulting in water vapor and uncombined hydrogen; and purifying the uncombined hydrogen via a hydrogen recirculation stack.

In some embodiments, the method further comprises drying the hydrogen generated in the electrolyzer stack. In some embodiments, the drying is accomplished via a pressure swing adsorber.

In some embodiments, the method further comprises storing the hydrogen in a hydrogen storage system.

In some embodiments, the method further comprises removing heat from one or more of the electrolyzer stack, the fuel cell stack, and the hydrogen recirculation stack via one or more heat exchangers. In some examples, the heat is provided to one or more heating loads.

In some embodiments, the electrolyzer stack is electrically connectable to an intermittent energy input. In some examples, the electrolyzer stack is electrically connectable to an intermittent energy input.

In some embodiments, the electrolyzer stack comprises a membrane electrolyte. In some embodiments, the fuel cell stack comprises a membrane electrolyte. In some embodiments, the hydrogen recirculation stack comprises an electrochemical hydrogen pump.

Provided herein is a system for generating and storing energy. The system generally comprises an electrolyzer stack, a fuel cell stack operably connected to the electrolyzer stack, and a plurality of hydrogen recirculation stacks operably connected to the fuel cell stack and to the electrolyzer stack. In some embodiments, the plurality of hydrogen recirculation stacks is arranged in a cascade. Generally, the hydrogen utilization of the system is about 95% or greater.

In some embodiments, the electrolyzer stack comprises a membrane electrolyte. In some examples, the membrane electrolyte comprises a proton exchange membrane, an anion exchange membrane, or a combination thereof. In some additional embodiments, the proton exchange membrane comprises sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or a combination thereof. In a preferred example, the proton exchange membrane comprises a sulfonated tetrafluoroethylene-based fluoropolymer-copolymer having a formula C₇HF₁₃O₅S·C₂F₄. In some additional embodiments, the anion exchange membrane comprises imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, or a combination thereof.

In some embodiments, the fuel cell stack comprises a membrane electrolyte. Preferably, the membrane electrolyte comprises a sulfonated tetrafluoroethylene-based fluoropolymer-copolymer having a formula C₇HF₁₃O₅S·C₂F₄. In some embodiments, the fuel cell stack is operable to deliver hydrogen to the plurality of hydrogen recirculation stacks.

In some embodiments, each of the plurality of hydrogen recirculation stacks comprises an electrochemical hydrogen pump. In some embodiments, the electrochemical hydrogen pump comprises a membrane electrolyte. In some embodiments, the membrane electrolyte comprises a proton exchange membrane. In still further embodiments, the membrane electrolyte comprises a sulfonated tetrafluoroethylene-based fluoropolymer-copolymer having a formula C₇HF₁₃O₅S·C₂F₄. In some embodiments, the plurality of hydrogen recirculation stacks is fluidly connected to the electrolyzer stack. In some embodiments, the plurality of hydrogen recirculation stacks is operable to deliver purified hydrogen to the fuel cell stack.

In some embodiments, the system further comprises a venturi device. Preferably, the venturi device is fluidly connected to the fuel cell stack and to one or more of the plurality of hydrogen recirculation stacks.

In some embodiments, the system further comprises power electronics. In some embodiments, the power electronics are electrically connectable to at least one of a DC energy input, an AC energy input, or a combination thereof. In some examples, the power electronics are electrically connected to at least one of a DC energy input, an AC energy input, or a combination thereof. In some embodiments, the power electronics are electrically connectable to at least one of a DC energy load, an AC energy load, or a combination thereof. In some examples, the power electronics are electrically connected to at least one of a DC energy load, an AC energy load, or a combination thereof.

In some embodiments, the system may further comprise a heat exchanger. In some embodiments, the heat exchanger is operably connected to at least one of the electrolyzer stack, the fuel cell stack, and one or more of the plurality of the hydrogen recirculation stacks. In some examples, the heat exchanger is thermally connected to at least one of the electrolyzer stack, the fuel cell stack, and one or more of the plurality of the hydrogen recirculation stacks. In some embodiments, the heat exchanger is operable to deliver heat from the electrolyzer stack, the fuel cell stack, and/or one or more of the plurality of the hydrogen recirculation stacks to a heating load. In some additional embodiments, the heat exchanger is operably connectable to a heat source. In some examples, the heat exchanger is operably connected to a heat source. In some additional examples, the heat exchanger is thermally connected to a heat source. In still further embodiments, the heat exchanger is operably connectable to a cooling source. In some examples, the heat exchanger is operably connected to a cooling source. In some additional examples, the heat exchanger is thermally connected to a cooling source.

In some embodiments, the electrolyzer stack is fluidly connectable to a water source. In some examples, the electrolyzer stack is fluidly connected to a water source.

In some embodiments, the system further comprises a dryer. In some embodiments, the dryer is selected from the group consisting of a pressure swing adsorption (PSA) system, a temperature swing adsorption (TSA) system, a hybrid PSA-TSA system, or a membrane purifier. In still further embodiments, the dryer comprises an inlet operable to receive wet hydrogen and an outlet operable to deliver dry hydrogen. Preferably, the dryer is fluidly connected to the electrolyzer stack, the fuel cell stack, and/or one or more of the plurality of the hydrogen recirculation stacks.

In some embodiments, the electrolyzer stack, the fuel cell stack, and/or one or more of the plurality of hydrogen recirculation stacks is fluidly connectable to a hydrogen storage system. Preferably, the electrolyzer stack, the fuel cell stack, and/or one or more of the plurality of hydrogen recirculation stacks is fluidly connected to a hydrogen storage system.

In some embodiments, the system further comprises a humidifier. In some embodiments, the fuel cell stack is fluidly connectable to the humidifier. Preferably, the fuel cell stack is fluidly connected to the humidifier.

Further provided herein are methods for generating and storing energy. Generally, the methods include generating hydrogen in an electrolyzer stack; combining the hydrogen with oxygen in a fuel cell stack, resulting in water vapor and uncombined hydrogen; and purifying the uncombined hydrogen via a plurality of hydrogen recirculation stacks. In some embodiments the electrolyzer stack is electrically connectable to an intermittent energy input.

In some embodiments, the method further comprises drying the hydrogen generated in the electrolyzer stack. In some embodiments, the drying is accomplished via a pressure swing adsorber.

In some embodiments, the method further comprises storing the hydrogen in a hydrogen storage system.

In some embodiments, the electrolyzer stack comprises a membrane electrolyte. In some embodiments the electrolyzer stack is electrically connectable to an intermittent energy input. In some examples, the electrolyzer stack is electrically connected to an intermittent energy input.

In some embodiments, the fuel cell stack comprises a membrane electrolyte.

In some embodiments, each of the plurality of hydrogen recirculation stacks comprises an electrochemical hydrogen pump.

In some embodiments, the method further comprises removing heat from one or more of the electrolyzer stack, the fuel cell stack, and the hydrogen recirculation stack via one or more heat exchangers. In some embodiments, the heat is provided to one or more heating loads.

Provided herein is a system for generating and storing energy. The system generally comprises an electrolyzer stack, a fuel cell stack operably connected to the electrolyzer stack, and a plurality of hydrogen recirculation stacks operably connected to the fuel cell stack and to the electrolyzer stack. In some embodiments, the plurality of hydrogen recirculation stacks is arranged in a cascade. Generally, the hydrogen utilization of the system is about 95% or greater.

Further provided herein are systems for generating and storing energy. The systems generally comprise an electrolyzer stack, a fuel cell stack operably connected to the electrolyzer stack, a hydrogen recirculation stack operably connected to the fuel cell stack and the electrolyzer stack, and a complex molecule stack operably connected to the electrolyzer stack and the hydrogen recirculation stack. Preferably, the fuel cell stack is fluidly connected to the electrolyzer stack, the hydrogen recirculation stack is fluidly connected to the fuel cell stack and the electrolyzer stack, and the complex molecule stack is fluidly connected to the electrolyzer stack and the hydrogen recirculation stack. Preferably, the hydrogen utilization of the system is about 95% or greater.

In some embodiments, the complex molecule stack is operable to produce a complex molecule selected from the group consisting of carbon-based molecules and nitrogen-based molecules. In some embodiments, the complex molecule stack is operable to produce ammonia. In some additional embodiments, the complex molecule stack is operable to produce methanol.

In some embodiments, the electrolyzer stack comprises a membrane electrolyte. In some examples, the membrane electrolyte comprises a proton exchange membrane, an anion exchange membrane, or a combination thereof. In some additional embodiments, the proton exchange membrane comprises sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or a combination thereof. In a preferred example, the proton exchange membrane comprises a sulfonated tetrafluoroethylene-based fluoropolymer-copolymer having a formula C₇HF₁₃O₅S·C₂F₄. In some additional embodiments, the anion exchange membrane comprises imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, or a combination thereof.

In some embodiments, the electrolyzer stack is electrically connectable to an intermittent energy input. In some additional embodiments, the intermittent energy input is selected from the group consisting of photovoltaics, wind, hydroelectric, or a combination thereof. In some examples, the electrolyzer stack is electrically connected to an intermittent energy input. In some embodiments, the electrolyzer stack is fluidly connectable to a water source. In still further embodiments, the electrolyzer stack is fluidly connectable to a hydrogen storage system.

In some embodiments, the fuel cell stack comprises a membrane electrolyte. In some embodiments, the membrane electrolyte comprises a sulfonated tetrafluoroethylene-based fluoropolymer-copolymer having a formula C₇HF₁₃O₅S·C₂F₄. In some embodiments, the fuel cell stack is fluidly connectable to a hydrogen storage system.

In some embodiments, the hydrogen recirculation stack comprises an electrochemical hydrogen pump. In some embodiments, the electrochemical hydrogen pump comprises a membrane electrolyte. In some embodiments, the membrane electrolyte comprises a proton exchange membrane. In still further embodiments, the membrane electrolyte comprises a sulfonated tetrafluoroethylene-based fluoropolymer-copolymer having a formula C₇HF₁₃O₅S·C₂F₄. In some additional embodiments, the hydrogen recirculation stack is fluidly connected to the electrolyzer stack. In still further embodiments, the hydrogen recirculation stack is fluidly connectable to a hydrogen storage system.

In some embodiments, the hydrogen recirculation stack comprises an inlet that is operable to receive wet hydrogen and/or dry hydrogen. In some additional embodiments the hydrogen recirculation stack comprises an outlet comprising purified hydrogen. Preferably, the outlet of the hydrogen recirculation stack is fluidly connected an inlet of the fuel cell stack. In still other preferred embodiments, the fuel cell stack comprises an outlet comprising hydrogen gas that is fluidly connected to the inlet of the hydrogen recirculation stack.

In some embodiments, the system further comprises a venturi device. Preferably, the venturi device is fluidly connected to the hydrogen recirculation stack and to the fuel cell stack.

In some embodiments, the system further comprises power electronics. In some embodiments, the power electronics are electrically connectable to at least one of a DC energy input, an AC energy input, or a combination thereof. In some examples, the power electronics are electrically connected to at least one of a DC energy input, an AC energy input, or a combination thereof. In further embodiments, the power electronics are electrically connectable to at least one of a DC energy load, an AC energy load, or a combination thereof. In some examples, the power electronics are electrically connected to at least one of a DC energy load, an AC energy load, or a combination thereof.

In some embodiments, the system further comprises a heat exchanger. In some embodiments, the heat exchanger is operably connected to at least one of the electrolyzer stack, the fuel cell stack, and the hydrogen recirculation stack. In some examples, the heat exchanger is thermally connected to at least one of the electrolyzer stack, the fuel cell stack, and the hydrogen recirculation stack. In some additional embodiments, the heat exchanger is operable to deliver heat from the electrolyzer stack, the fuel cell stack, and/or the hydrogen recirculation stack to a heating load. In further embodiments, the heat exchanger is operably connectable to a heat source. In some examples, the heat exchanger is operably connected to a heat source. In still further examples, the heat exchanger is thermally connected to a heat source. In further embodiments, the heat exchanger is operably connected to a cooling source. In some examples, the heat exchanger is thermally connected to a cooling source.

In some embodiments, the system further comprises a water source. Preferably, the electrolyzer stack is fluidly connectable to the water source. In some examples, the electrolyzer stack is fluidly connected to the water source.

In some embodiments, the system further comprises a dryer. In some embodiments, the dryer is selected from the group consisting of a pressure swing adsorption (PSA) system, a temperature swing adsorption (TSA) system, a hybrid PSA-TSA system, or a membrane purifier. In additional embodiments, the dryer comprises an inlet operable to receive wet hydrogen and an outlet operable to deliver dry hydrogen. In still further embodiments, the dryer is fluidly connected to the electrolyzer stack and to the fuel cell stack.

In some embodiments, the system further comprises a humidifier. In some embodiments, the humidifier is fluidly connected to the fuel cell stack.

### BRIEF DESCRIPTION OF THE DRAWINGS

FIG. 1 shows a flow sheet of an exemplary system of the present disclosure.

FIGS. 2A-2E show various configurations for a water purification loop with a deionization bed. FIG. 2A shows a flow sheet of a system including an ion exchange bed connected in parallel with the electrolyzer stack and the water source. FIG. 2B shows a flow sheet of a system including a plurality of ion exchange beds. FIG. 2C shows a flow sheet of another system including an ion exchange bed. FIG. 2D shows a flow sheet of a system including an acid/base input for regeneration of the ion exchange resin. FIG. 2E shows a flow sheet of a system that includes a plurality of heat exchangers fluidly connected to an ion exchange bed.

FIG. 3 shows a flow sheet of a system including a cascade of hydrogen recirculation stacks.

FIG. 4 shows a flow sheet of a system including a complex molecule stack for generating ammonia.

FIG. 5 shows a flow sheet of a system including a complex molecule stack for generating carbon-based molecules.

### DETAILED DESCRIPTION

Described herein are systems for generating electricity and storing energy. The systems generally comprise an electrolyzer stack, a fuel cell stack, and a hydrogen recirculation stack. The hydrogen recirculation stack prevents loss of excess hydrogen that is not converted to water in the fuel cell stack, thereby increasing the overall efficiency of the system.

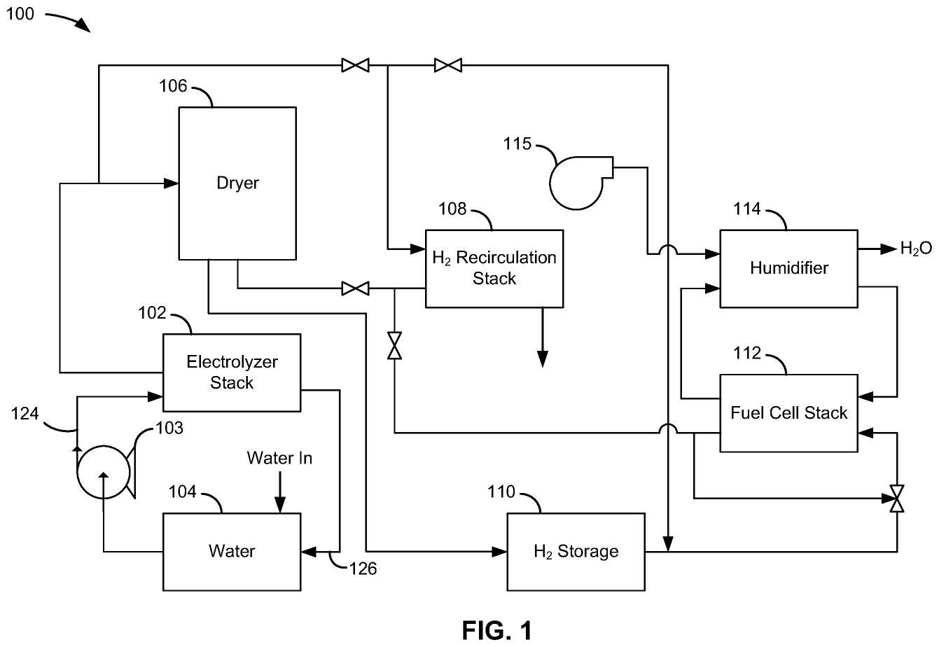

Referring to FIG. 1, the system 100 comprises an electrolyzer stack 102. Electrolyzer stacks 102 (also referred to as electrochemical stacks) and methods of making and procuring electrolyzer stacks are generally known in the art. Water from a water source 104 is electrolyzed in an electrolyzer cell of the electrolyzer stack 102 to form hydrogen (e.g., via hydrogen ion diffusion through an electrolyte from an anode side of the electrolyzer cell to a cathode side of the electrolyzer cell). The electrolyzer stack 102 may include a single electrochemical cell for electrolyzing water or may include a plurality of electrochemical cells. In particular, electrolyzer stacks 102 suitable for use in the system of the present disclosure are described in U.S. application Ser. No. 17/101,232 entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety. In some embodiments, the system may comprise a plurality of electrolyzer stacks 102.

The electrolyzer stack 102 may comprise a membrane electrolyte such as a proton exchange membrane (PEM). The PEM may comprise any suitable proton exchange (e.g., hydrogen ion transport) polymer membrane, such as sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystyrene (S-SEBS), or, in some examples, a Nafion® membrane composed of sulfonated tetrafluoroethylene based fluoropolymer-copolymer having a formula C₇HF₁₃O₅S·C₂F₄, and combinations thereof.

Alternatively, or additionally, the electrolyzer stack may comprise a membrane electrolyte such an anion exchange membrane (AEM). The AEM may comprise any suitable anion exchange polymer membrane, such as imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, and other anion exchange materials known in the art and combinations thereof.

The electrolyzer stack 102 comprises an inlet operable to receive water from a water source 104 or water reservoir (e.g., municipal water supply, purified water, etc.). The inlet, and thus the electrolyzer stack 102, may therefore be fluidly connected to the water source 104. The water may be pumped from the water source 104 to the inlet of the electrolyzer stack 102 via a pump 103. The water travels through a feed conduit 124 to the electrolyzer stack 102. Any pump suitable for delivering water from the water source 104 to the inlet of the electrolyzer stack 102 may be used for this purpose. Preferably, the water is purified to minimize the amount of impurities introduced into the electrolyzer stack.

The electrolyzer stack 102 also comprises an outlet operable to deliver hydrogen to the system 100. The outlet may be fluidly connected to a dryer 106, a hydrogen recirculation stack(s) 108, or to a hydrogen storage system 110, or a combination thereof. The gas flowing from the electrolyzer stack 102 through the outlet consists essentially of hydrogen and water. The hydrogen flowing from the electrolyzer may have a purity of about 95% to about 98% by weight. Excess water from the electrolyzer stack 102 may be delivered back to the water source 104 via a recirculation circuit 126.

The electrolyzer stack 102 may receive input energy (i.e., electricity) from an intermittent source such as solar power (including photovoltaic and reflective), wind power, tidal power, wave power, and other intermittent energy sources known in the art. Alternatively, or in addition, the electrolyzer stack 102 may receive input energy from an electricity grid (e.g., a regional electricity grid, a municipal electricity grid, or a microgrid). The electrolyzer stack 102 may therefore be electrically connectable to an intermittent energy input.

The system 100 further comprises a fuel cell stack 112. The fuel cell stack comprises a fuel cell or a plurality of fuel cells. For example, the fuel cell stack 112 may comprise one, two, three, four, five, six, seven, eight or more fuel cells. Fuel cells and methods of making and procuring fuel cells are generally well known in the art. The fuel cell comprises a cathode, an anode, an anode catalyst, and an electrolyte. Oxygen passes through the cathode of the fuel cell. Hydrogen passes through the anode of the fuel cell, and the anode catalyst operates to split the hydrogen molecules into electrons and protons. The protons pass through the electrolyte and the electrons are forced through a circuit, thereby generating an electric current and heat. At the cathode, the protons, electrons, and oxygens combine to produce water molecules. The purity of hydrogen being delivered to the fuel cell must generally be at least about 99.97%, or in some cases at least about 99.995%.

Generally, the fuel cell stack 112 comprises a first inlet, a second inlet, a first outlet, and a second outlet. The first inlet is operable to receive hydrogen from the electrolyzer stack 102, from a hydrogen storage system 110, from a dryer 106, and/or from a hydrogen recirculation stack 108 or a plurality of hydrogen recirculation stacks 108. The first inlet may therefore be fluidly connected to the hydrogen storage system 110, the dryer 106, and/or the hydrogen recirculation stack(s) 108. The second inlet is operable to receive humidified air from a humidifier 114. The second inlet may therefore be fluidly connected to the humidifier. The first outlet is operable to deliver excess hydrogen from the fuel cell stack 112 to the hydrogen recirculation stack(s) 102 and/or to the hydrogen storage system 110. Alternatively or additionally, the first outlet may be operable to recycle the excess hydrogen to the first inlet of the fuel cell stack 112. Therefore, the first outlet may be fluidly connected to the hydrogen recirculation stack(s) 108, the hydrogen storage system 110, and/or to the first inlet of the fuel cell stack 112. The second outlet of the fuel cell stack 112 comprises oxygen-depleted air and water vapor and is operable to deliver water vapor to the humidifier 114; therefore, the second outlet of the fuel cell stack 112 may be fluidly connected to the humidifier 114.

In some examples, oxygen-depleted air from the second outlet of the fuel cell stack 112 may be provided for various industries and applications that require storage in an atmosphere comprising low levels of oxygen to prevent oxidation, such as food storage, fire prevention, artwork storage and restoration, etc. The oxygen-depleted air may be collected and stored using methods known to those having ordinary skill in the art or may be provided directly to the industries and applications that require the oxygen-depleted air.

In some examples, the second outlet of the fuel cell stack 112 may be operable to deliver water vapor to a humidification system for a building. Alternatively, the water vapor may be condensed for other purposes, such as potable water, grey water pools, etc.

The fuel cell electrolyte may comprise a proton exchange membrane (PEM) electrolyte. The PEM may comprise any suitable proton exchange (e.g., hydrogen ion transport) polymer membrane, such as Nafion® membrane composed of sulfonated tetrafluoroethylene-based fluoropolymer-copolymer having a formula C₇HF₁₃O₅S·C₂F₄.

The fuel cell stack 112 may be connected in parallel with a venturi device, e.g., a venturi pump. The venturi device may enable more efficient removal of excess hydrogen from the fuel cell stack. The venturi device may be fluidly connected to the first outlet of the fuel cell stack and to the first inlet of a hydrogen recirculation stack 108. Venturi devices are particularly favorable for use in the systems of the present disclosure because they operate based on differences in pressure and require no input energy source, thus increasing the overall efficiency of the system. Venturi devices and methods of making or procuring the same are generally known to those having ordinary skill in the art.

The system further comprises a hydrogen recirculation stack 108 or a plurality of hydrogen recirculation stacks. The hydrogen recirculation stack 108 may comprise a hydrogen recirculation pump or a plurality of hydrogen recirculation pumps, and/or an electrochemical hydrogen compressor or a plurality of electrochemical hydrogen compressors. For example, the hydrogen recirculation stack 108 may comprise one, two, three, four, five, six, seven, eight or more hydrogen recirculation pumps. The system may comprise one hydrogen recirculation stack 108 or a plurality of hydrogen recirculation stacks 108 arranged in a cascade (not pictured in FIG. 1). Hydrogen recirculation pumps and methods for procuring or making hydrogen recirculation pumps are generally known in the art. In particular, hydrogen recirculation pumps suitable for use in the system of the present disclosure are described in U.S. application Ser. No. 17/101,232 entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety.

The hydrogen recirculation stack(s) 108 may be, for example, an electrochemical pump. As used in this context, an electrochemical pump shall be understood to include a proton exchange membrane (i.e., a PEM electrolyte) disposed between an anode and a cathode. The hydrogen recirculation stack(s) 108 may generate protons moveable from the anode through the proton exchange membrane to the cathode form pressurized hydrogen. Thus, such an electrochemical pump may be particularly useful for recirculating hydrogen within the system at least because the electrochemical pumping provided by the electrochemical pump separates hydrogen from water in the mixture delivered to the hydrogen pump via a pump conduit while also pressurizing the separated hydrogen to facilitate moving the pressurized hydrogen to the inlet portion of a dryer.

Each hydrogen recirculation stack 108 comprises a first inlet, a second inlet, a first outlet, and a second outlet. The first inlet is operable to receive dry hydrogen from the dryer 106, the first outlet of the fuel cell stack 112, from a hydrogen storage system 110, and/or from another hydrogen recirculation stack (not pictured in FIG. 1). Therefore, the first inlet may be fluidly connected to the dryer 106, the first outlet of the fuel cell stack 112, to a hydrogen storage system 110, and/or to a hydrogen recirculation stack 108. The second inlet is operable to receive wet hydrogen from the electrolyzer stack 102. Therefore, the second inlet may be fluidly connected to the electrolyzer stack 102. The first outlet is operable to provide a stream comprising purified hydrogen and may be fluidly connected to another hydrogen recirculation stack 108 when a plurality of hydrogen recirculation stacks is present. The first outlet may be fluidly connected to a hydrogen storage system 110 or to a system or process requiring purified hydrogen, such as the fuel cell stack 112. In preferred embodiments, the first outlet of the hydrogen recirculation stack 108 is fluidly connected to the fuel cell stack 112. The second outlet may comprise a purge stream comprising hydrogen, oxygen, and water. The purge stream may be recycled in the system of the present disclosure, or the purge stream may vent to the atmosphere. The second outlet in each hydrogen recirculation stack 108 when there is a plurality of hydrogen recirculation stacks arranged in a cascade may be fluidly connected to a common pipe.

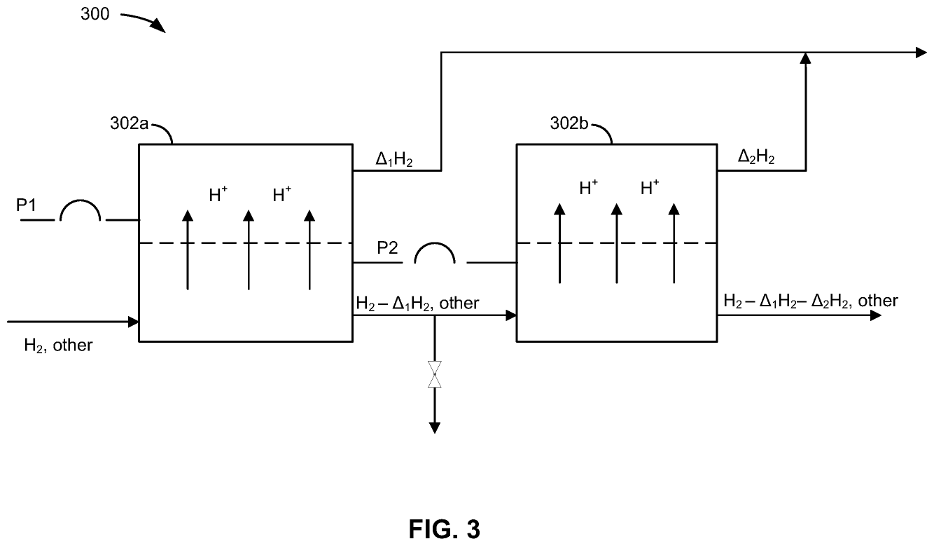

Referring now to FIG. 3, a system 300 comprising a plurality of hydrogen recirculation stacks 302a, 302b arranged in a cascade is shown. The input of the first hydrogen recirculation stack 302a includes hydrogen gas and other impurities, such as water or oxygen. The outlet of the first hydrogen recirculation stack 302a is an amount of purified hydrogen gas Δ₁H₂ and the remaining hydrogen gas (H₂-Δ₁H₂) and other impurities. The purified hydrogen gas Δ₁H₂ is then directed to other system components. A portion of the remaining hydrogen gas H₂-Δ₁H₂ and impurities may be discharged or recycled to other portions of the system 300. A portion of the remaining hydrogen gas H₂-Δ₁H₂ and impurities is then directed to the second hydrogen recirculation stack 302b. The purified hydrogen gas Δ₂H₂ from the second hydrogen recirculation stack 302b may then be combined with the purified hydrogen gas purified hydrogen gas Δ₁H₂ from the first hydrogen recirculation stack 302a. The remaining hydrogen gas H₂-Δ₁H₂-Δ₂H₂ and impurities may be discharged or recycled to other portions of the system 300.

In systems comprising a plurality of hydrogen recirculation stacks 302, the electrical current delivered to each of the plurality of hydrogen recirculation stacks 302 may be selected based on the operating current of the fuel cell stack 112 and the electrolyzer stack 102. For example, the current within the hydrogen recirculation stack 302 may be based on a ratio of current delivered to the electrolyzer stack 102 and fuel cell stack 112. This may have a self-balancing effect on the system 300; i.e., by taking the input of the ratio of currents from the fuel cell stack and the electrolyzer stack, the hydrogen recirculation stack may be able to operate in an automatic mode that directs the power of the hydrogen recirculation stack in order to meet the demands of the system. Generally, the ratio of currents through the fuel cell stack and the electrolyzer stack is easier to measure than the ratio of flow rates through the stacks. Thus, utilizing the ratio of currents provides more accurate and dynamic controls input to control software, which may send commands to the recirculation stack to provide proper current based on the measured ratios. External controls or overrides may also change the current of the hydrogen recirculation stack 302.

In some embodiments, the plurality of hydrogen recirculation stacks 302 may be fluidly connected to a pressurized hydrogen storage system 110. The pressurized hydrogen storage system 110 may store hydrogen at a pressure from about 350 bar to about 700 bar; for example, about 350 bar, 400 bar, 450 bar, 500 bar, 550 bar, 600 bar, 650 bar, or about 700 bar. In such embodiments, the plurality of hydrogen recirculation stacks 302 may be utilized with reversed current to expand the hydrogen stored in the pressurized hydrogen storage system 110, thereby generating additional power. By utilizing differential pressure (P1-P2) across the plurality of hydrogen recirculation stacks 302, flow can be reversed through the stacks thereby generating a voltage and current that may provide additional power. In such embodiments, the voltage is low and so power conditioning may not be required.

The plurality of hydrogen recirculation stacks 302 may be operated such that all of the hydrogen recirculation stacks 302 are operating at the same time, or a limited number of the plurality of hydrogen recirculation stacks 302 may be operated at a time. For example, when operating conditions require that the amount of vented hydrogen must be minimized, all of the hydrogen recirculation stacks 302 in the cascade may be used. As another example, when operating conditions allow a certain amount of hydrogen to be vented, less than the total number of hydrogen recirculation stacks 302 in the cascade may be used.

The plurality of hydrogen recirculation stacks 302 may comprise one or more bypass valves. The bypass valve functions to allow the first output from a hydrogen recirculation stack to bypass the remaining hydrogen recirculation stacks 302 in the cascade. The bypass valve may comprise any valve known to those having skill in the art, including a ball valve, butterfly valve, check valve, diaphragm valve, gate valve, globe valve, needle valve, pinch valve, plug valves, etc. Additionally, the bypass valve may be operated manually, pneumatically, hydraulically, or electrically. Each bypass valve may connect the first outlet of a hydrogen recirculation stack to a common pipe comprising purified hydrogen.

The pressure of the hydrogen provided to the hydrogen recirculation stacks 302 is generally from about 1 bar to about 2 bar; however, the pressure may be higher or lower depending on the requirements of the system and the equipment used.

The hydrogen recirculation stacks may serve two functions that result in reduction in overall emissions from the system. First, the hydrogen recirculation stacks may be utilized to capture and recirculate hydrogen which would otherwise be vented or otherwise lost from the dryer. Second, the hydrogen recirculation stacks may be utilized to create a purified recirculation stream for the fuel cell stack, which may be connected in parallel with a venturi device, thereby avoiding the need to purge the hydrogen stream to the first inlet of the fuel cell stack or the air stream to the second inlet of the fuel cell stack which may contain nitrogen gas that diffuses through the electrolyte of the fuel cell stack. Moreover, when a plurality of hydrogen recirculation stacks is utilized, the purity of the hydrogen may increase from 95-98% to over 99%, over 99.9%, over 99.99%, or over 99.999%.

Returning now to FIG. 1, the system 100 further comprises a dryer 106. The dryer 106 may be, for example, a pressure swing adsorption (PSA) system, a temperature swing adsorption (TSA) system, a hybrid PSA-TSA system, or a membrane purifier. The dryer 106 comprises an inlet portion and an outlet portion. The inlet portion is operable to receive wet hydrogen from the electrolyzer stack 102. The inlet portion may therefore be fluidly connected to the electrolyzer stack 102. The hydrogen gas may have a purity of about 95% to about 98%, wherein the major impurity is water. The outlet portion is operable to provide dry hydrogen to the hydrogen recirculation stack 108, the fuel cell stack 112, and/or a hydrogen storage system 110. The outlet portion may therefore be fluidly connected to the hydrogen recirculation stack 108, the fuel cell stack 112, and/or a hydrogen storage system 110. The dryer 106 may also comprise a second outlet comprising low pressure hydrogen, e.g., from about 1 to about 2 bar, or less than about 1 bar. The second outlet may be fluidly connected to the electrolyzer stack and/or to the hydrogen recirculation stack 108.

The dryer 106 may further comprise a purge stream. The purge stream is operable to remove excess water vapor and other gases from the hydrogen. The purge stream may comprise hydrogen having a concentration from about 5% to about 25%. For example, the hydrogen may have a concentration from about 5% to about 10%, about 5% to about 15%, about 5% to about 20%, about 5% to about 25%, about 10% to about 25%, about 15% to about 25%, about 20% to about 25%, about 5%, about 10%, about 15%, about 20%, or about 25%.

The dryer 106 may include one or more beds of a water-adsorbent material, such as activated carbon, silica, zeolite or alumina. The dryer 106 may include a membrane such as a PEM electrolyte. As the gas consisting essentially of hydrogen and water moves through from the inlet portion to the outlet portion of the dryer, at least a portion of the water may be removed from the product mixture through adsorption of either water or hydrogen in the bed of water-adsorbent material. If hydrogen is adsorbed, then it is removed into the outlet conduit during a pressure and/or temperature swing cycle. If water is adsorbed, then it is removed into a pump conduit during the pressure and/or temperature swing cycle. In some instances, adsorption carried out by the dryer may be passive, without the addition of heat or electricity that could otherwise act as ignition sources of an ignitable hydrogen-containing mixture. In such instances, however, considerations related to backpressure created by the dryer 106 in fluid communication with the electrolyzer stack 102 may limit the size and, therefore, the single-pass effectiveness of the dryer in removing moisture from the product stream.

The system may further comprise a hydrogen storage system 110. Systems and methods for storing hydrogen are generally well-known in the art, for example, storage tanks. One or more of the electrolyzer stack 102, the fuel cell stack 112, the hydrogen recirculation stack(s) 108, a complex molecule stack 120, and the dryer 106 may be fluidly connectable to a hydrogen storage system 110. The hydrogen storage system 110 may comprise pressurized hydrogen. The pressurized hydrogen may be stored at a pressure from about 350 bar to about 700 bar; for example, about 350 bar, 400 bar, 450 bar, 500 bar, 550 bar, 600 bar, 650 bar, or about 700 bar.

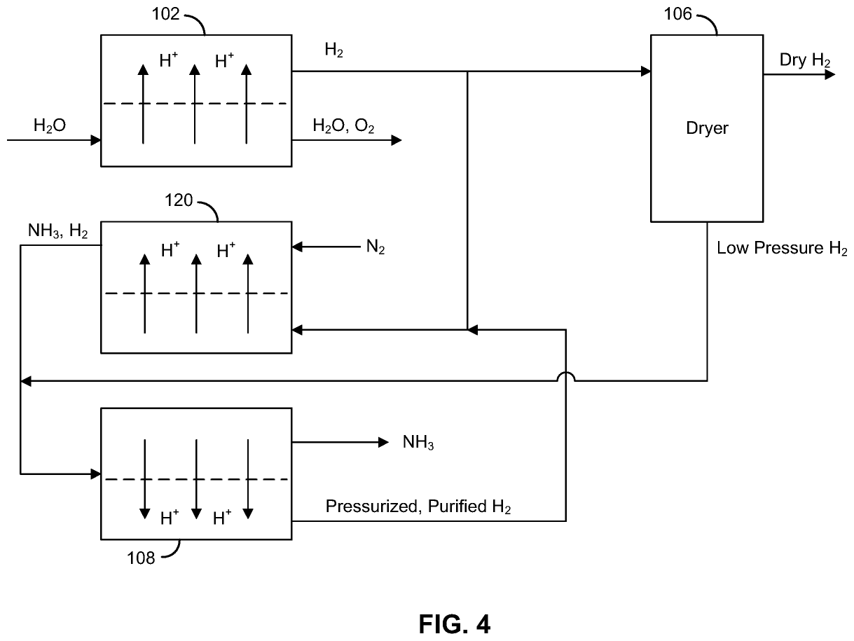

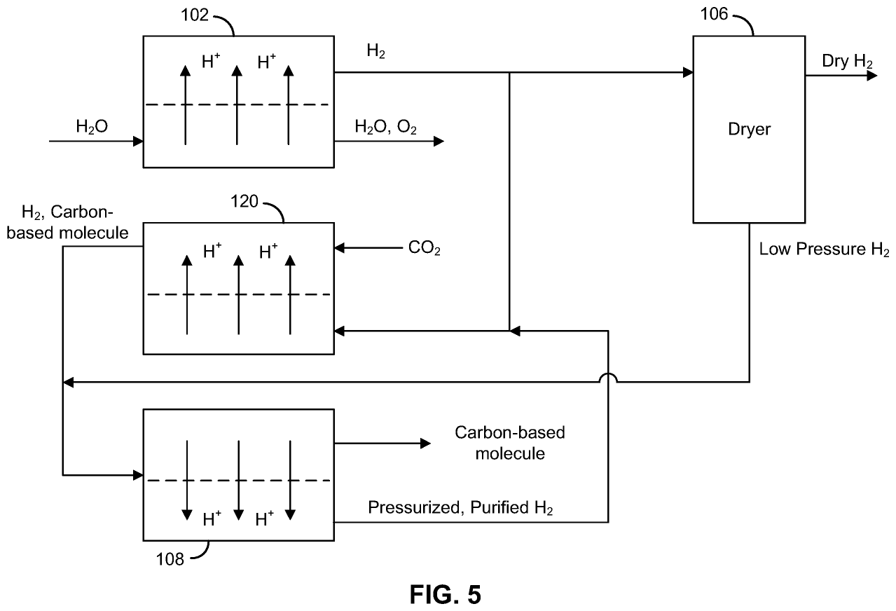

Turning now to FIGS. 4 and 5, the system 100 may further comprise a complex molecule stack 120. The complex molecule stack 120 is operable to produce one or more complex molecules. The complex molecule stack 120 may comprise an electrochemical reactor including a PEM cell. As used herein, the “complex molecule stack” may be called an “ammonia stack” when the complex molecule stack is capable of generating ammonia, or a “carbon stack” when the complex molecule stack is capable of generating a carbon-based complex molecule.

The complex molecule stack 120 comprises a first inlet, a second inlet, a first outlet, and a second outlet. The first inlet is operable to receive hydrogen from the electrolyzer stack 102, from the dryer 106, and/or from the hydrogen recirculation stack(s) 108. The first inlet may therefore be fluidly connected to the electrolyzer stack 102, the dryer 106, and/or to the hydrogen recirculation stack(s) 108. The second inlet is operable to receive a complex molecule precursor, discussed more in the following paragraph. The first outlet is operable to deliver a mixture of the complex molecule and hydrogen to a hydrogen recirculation stack 108, which is operable to separate the hydrogen gas from the complex molecule. Thus, the first outlet may be fluidly connected to a hydrogen recirculation stack 108. The second outlet may comprise hydrogen and the complex molecule precursor and may be operable to recycle the hydrogen and the complex molecule precursor or vent the hydrogen and the complex molecule precursor to a scrubber or to the atmosphere.

The second inlet is operable to receive a complex molecule precursor. For example, when the complex molecule stack 120 is an ammonia stack, the complex molecule precursor comprises nitrogen gas. Therefore, in this example, the second inlet may be fluidly connected to a fan or blower that introduces air into the ammonia stack, or to a nitrogen storage system that provides pure nitrogen to the ammonia stack. Complex molecule stacks capable of producing ammonia suitable for use in the system of the present disclosure are described in U.S. application Ser. No. 17/101,224 entitled “SYSTEMS AND METHODS OF AMMONIA SYNTHESIS”, the entire contents of which are incorporated by reference herein.

In another example when the complex molecule stack is a carbon stack capable of producing methanol, the complex molecule may comprise carbon dioxide. Therefore, in this example, the second inlet may be fluidly connected to a fan or blower that introduces air into the carbon stack, to a carbon dioxide storage system that provides pure carbon dioxide to the carbon stack, or to an exhaust stream from another system or process that provides a stream of carbon dioxide that otherwise would be vented to the atmosphere.

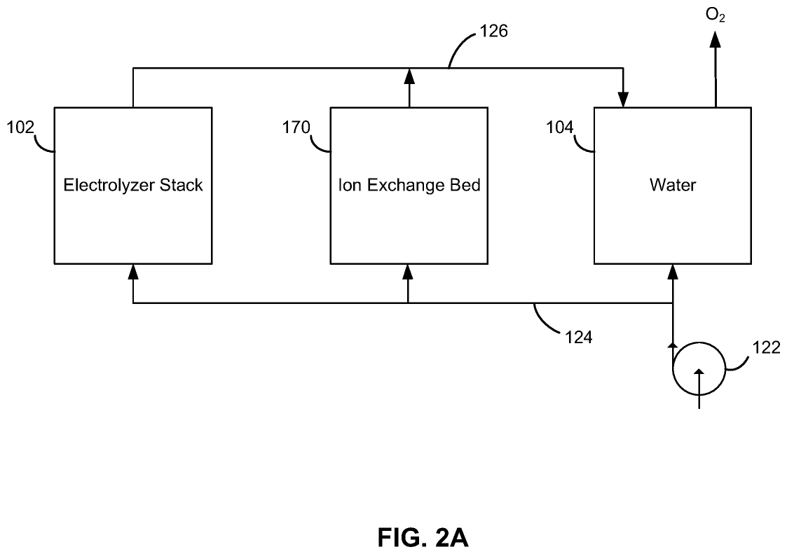

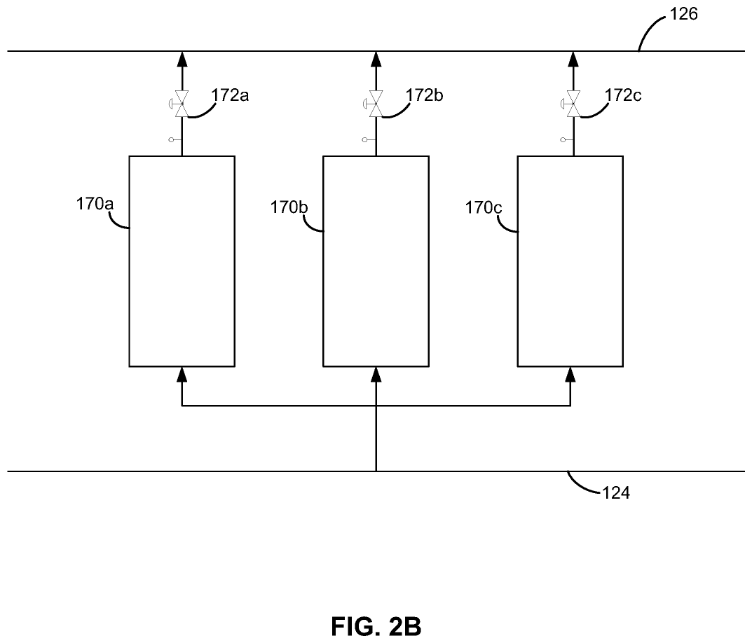

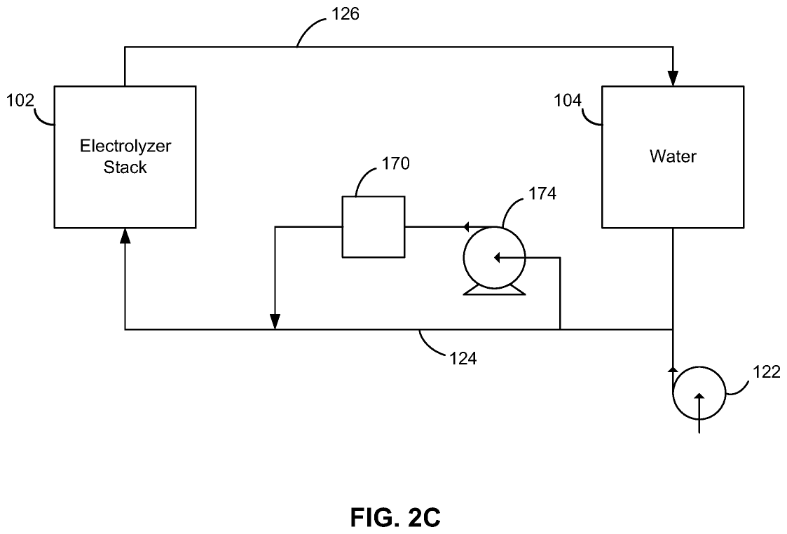

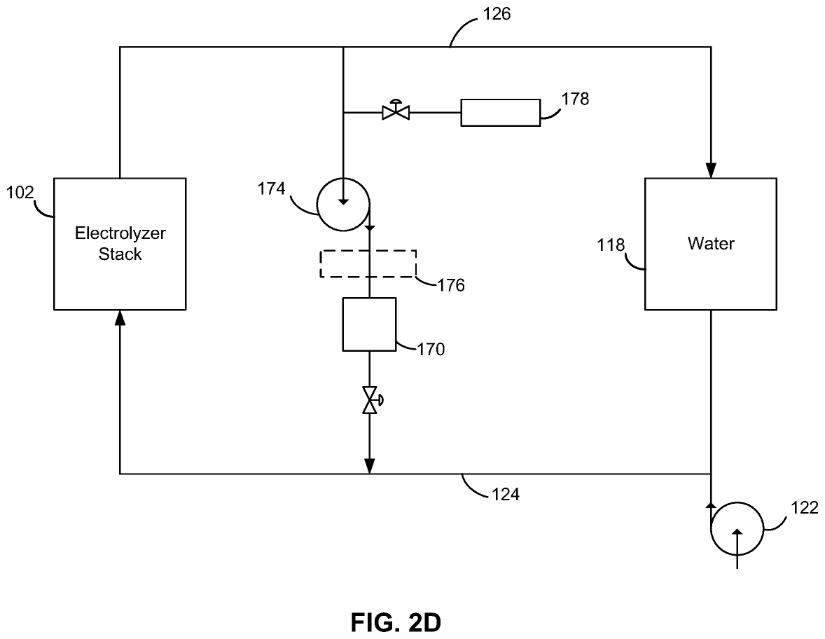

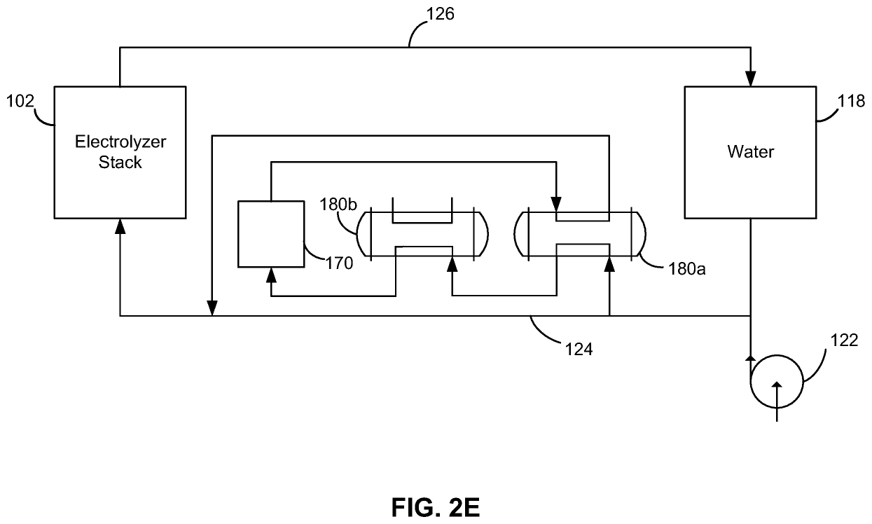

The system 100 may include filtration or other processing equipment useful for purification of process water to reduce the concentration of contaminants that may degrade performance of other components (e.g., the electrolyzer stack 102 or the fuel cell stack 112) over time. As shown in FIG. 2A, the processing equipment comprises an ion exchange bed 170 in fluid communication with the feed conduit 124 and the recirculation circuit 126, such that water is directed from the feed conduit 124 into the ion exchange bed 170 and water from the ion exchange bed 170 is directed to the recirculation circuit 126. This arrangement is advantageous for electrolyzer systems as compared to an arrangement where water from the recirculation circuit 126 flows into the ion exchange bed because gaseous oxygen carried in the water of the recirculation circuit 126 would interrupt the operation of the ion exchange bed 170. The ion exchange bed 170 improves water purity and increases the life of the electrolyzer stack 102. The pump 103 may be operable to provide a pressurized flow through the ion exchange bed 170.

The ion exchange bed 170 may comprise one or more ion exchange resins located within distinct compartments in the ion exchange bed 170. For example, a resin with a high ion exchange rate may be located in a first compartment of the ion exchange bed, whereas a second resin with a low ion exchange rate may be located in a second compartment of the ion exchange bed. The controller 148 may be operable to direct the flow of the water to one or more of the compartments based on the needs of the system.

The temperature of the water flowing through or flowing from the ion exchange bed 170 may be increased or decreased via one or more heat exchangers. The heat exchanger(s) may comprise a heat exchange fluid such as water, steam, glycol, air, or other heat exchange fluids known in the art. The heat exchanger(s) may extend the usable lifetime of the resin.

The heat exchanger may also comprise a heating element to provide heat sufficient to prevent freezing during off-line conditions when the ambient temperature is below freezing. In such embodiments, the heater may not be operated at times when hydrogen is being produced at the cathode of the electrolyzer stack 102 and oxygen is being produced at the anode of the electrolyzer stack 102.

The ion exchange bed comprises an ion exchange resin, preferably in the form of beads, comprising a cation exchange media and an anion exchange media. Ion exchange beds of this type and methods of making or procuring the same are generally well-known in the art. Generally, the ion exchange resin may conduct an H⁺/OH⁻ exchange; however, it is also envisioned that the ion exchange resin may also or alternatively conduct NH₄⁺/OH⁻ exchange, weak acid/weak base exchange, or other exchange mechanisms. The ion exchange resin is preferably capable of withstanding temperatures of up to 100° C., or more preferably up to 90° C. The relative amounts of cation exchange media and anion exchange media may be adjusted based on the known or predicted quality of the water used in the system. Additionally, the type of ion exchange resin used may be chosen based upon impurities of the water in the region in which the system operates. In some embodiments, the ion exchange resin comprises a sulfonic acid functional group, a trimethylammonium functional group, a quaternary ammonium functional group, and combinations thereof. The ion exchange resin may comprise a polymer matrix structure, such as cross-linked divinylbenzene or cross-linked polystyrene. Some non-limiting examples of ion exchange resins that may be used in the ion exchange bed include Dupont's AmberTec™ UP6150 H/OH Ion Exchange Resin, Dupont's AmberLite™ MB20 H/OH Ion Exchange Resin, and Thermax's TULSION® MB—1518.

In some embodiments, a plurality of ion exchange beds 170 may be included in the system. The plurality of ion exchange beds may be fluidly connected in parallel, series, or series-parallel. A plurality of isolation valves may also be included to isolate one or more of the plurality of ion exchange beds from water flow. This may increase the life of the ion exchange beds not in service and may provide redundancy in the event that one of the ion exchange beds fails. One or more of the plurality of ion exchange beds have a smaller capacity as compared to the other ion exchange bed(s). This smaller ion exchange bed may be used in the event that a larger ion exchange bed fails to provide continuous purification and allow continued operation of the system until the larger ion exchange bed is repaired or replaced.

The flow of water through the ion exchange bed(s) 170 in any of the above arrangements may be increased or decreased via a controller based on various parameters, including the temperature of the water, the current, the age of the ion exchange bed, the number of ion exchange beds in use, a decline in stack performance, a change in water conductivity as compared to a predetermined threshold value, a change in water pH as compared to a predetermined threshold value, etc. Additionally, one or more ion exchange beds may be turned on or shut down in response to any of the above events.

Turning now to FIG. 2B, the system may comprise a plurality of ion exchange beds (170a, 170b, 170c). For example, the system may comprise one or more ion exchange beds, two or more ion exchange beds, three or more ion exchange beds, and so on.

The system may further comprise a plurality of isolation valves (172a, 172b, 172c), each fluidly connected to an ion exchange bed (170a, 170b, 170c) and operable to fluidly isolate the respective ion exchange bed (170a, 170b, 170c). In some arrangements, all of the plurality of ion exchange beds may be functional during operation. In other arrangements, one or more of the plurality of ion exchange beds may be non-functional during operation, such as to preserve the operating life of the ion exchange resin or for maintenance and repair. This arrangement is thus advantageous as it provides redundancy to the system.

Each of the plurality of isolation valves may be in electrical communication with a controller. Each isolation valve 172 may be operable to open or close in response to an operating condition detected by the controller. Such operating conditions may include the conductivity of the water exceeding a predetermined threshold value, the pH of the of the water exceeding a predetermined threshold value, a decline in electrolyzer stack 102 performance, etc. By opening and closing the isolation valve(s) 172 in response to such operating conditions, the operable lifespan of the ion exchange bed(s) 170 may be increased.

Turning now to FIG. 2C, the ion exchange bed 170 may be arranged in parallel with feed conduit 124. In such an arrangement, a second pump 174 may be in fluid communication with the ion exchange bed and with the feed conduit 124 to provide pressurized flow of water through the ion exchange bed. The second pump 174 may be a variable speed pump to provide a variable flow rate of water to the ion exchange bed. The second pump 174 may be in electrical communication with the controller. The speed of the second pump 174 may be controlled by the controller and may be adjusted up or down in response to an operating condition detected by the controller 148. Such operating conditions may include the temperature of the water exceeding a predetermined threshold value, the current to the electrochemical stack 200 exceeding a predetermined threshold value, the conductivity of the water exceeding a predetermined threshold value, the pH of the of the water exceeding a predetermined threshold value, a decline in electrolyzer stack 102 performance, the age of the ion exchange bed 170, the number of ion exchange beds 170 in operation, etc.

Turning now to FIG. 2D, the ion exchange bed may be arranged such that it receives water from the recirculation circuit 126 for purification and provides water to the feed conduit 124 (i.e., an “off-line polishing” arrangement). This arrangement places the inlet to the ion exchange bed downstream of the electrolyzer stack 102. This arrangement may further include an input 178 for the introduction of an acid or a base to recover the membrane function of the electrolyzer stack 102. The acid or base may comprise hydrochloric acid, sulfuric acid, sodium hydroxide, calcium hydroxide, ammonium hydroxide, etc. This embodiment includes a second pump 174 operable to direct water to the ion exchange bed 170. Further, in this arrangement, the operation of the ion exchange bed loop may be interlocked with current in the electrolyzer stack 102 such that when a current is detected the ion exchange bed 170 will be isolated. This prevents introducing oxygen to the ion exchange bed 170, as oxygen is produced when a current is being run through the electrolyzer stack 102.

Turning now to FIG. 2E, the ion exchange bed 170 may be arranged such that it receives water from the feed conduit 124, which then passes through a first heat exchanger 180a and a second heat exchanger 180b. The first heat exchanger 180a may be in thermal communication with the outlet of the ion exchange bed 170 to pre-heat the water entering second heat exchanger 180b. the second heat exchanger 180b may receive thermal energy from an external source, such as a heat exchange fluid. After the water is purified in the ion exchange bed 170, the water may be delivered to the electrolyzer stack 102 after being cooled by the first heat exchanger 180a.

The system may further comprise power electronics. The power electronics may be formed or provided in a single assembly that connects the input energy, the electrolyzer stack, the fuel cell stack, the hydrogen recirculation stack(s), and/or additional energy outputs or energy loads. The power electronics may be operable to connect to DC energy inputs, AC energy inputs, and combinations thereof. The power electronics may be operable to connect to DC energy loads, AC energy loads, and combinations thereof. Further, the power electronics may allow for direct delivery of energy inputs to the energy loads in parallel with the operation of the energy storing electricity generator during times when those energy input sources are available. This is particularly useful when the energy inputs comprise intermittent energy sources. The power electronics may comprise a GaN inverter board, and integrated power board, control cards, a display board, and/or a DAB converter. In some embodiments, the power electronics may be the power electronics described in U.S. application Ser. No. 17/360,153 entitled “IMPEDANCE MONITORING OF A MODULAR ELECTROLYSIS SYSTEM”, the contents of which are incorporated by reference herein in their entirety.

The system may further comprise a humidifier 114. Humidifiers and methods of making and procuring humidifiers are well known in the art. The humidifier 114 is operable to provide a source of humid air to the fuel cell stack 112. Without humidification, fuel cell membranes may become too dry and reduce proton transport in the fuel cell stack 112, thereby decreasing oxygen reduction at the cathode within the fuel cell.

The humidifier 114 may comprise a first inlet, a second inlet, a first outlet, and a second outlet. The first inlet of the humidifier 114 may be operable to receive air from a blower 115. Therefore, the humidifier may be fluidly connected to a blower 115. The second inlet may be operable to receive water from a water source 104 and/or from the second outlet of the fuel cell stack 112. Therefore, the second inlet of the humidifier 114 may be fluidly connected to a water source 104 and/or to the second outlet of the fuel cell stack 112. The first outlet of the humidifier may be operable to deliver excess water vapor from the humidifier 114. The first outlet may be fluidly connected to a water source 104, the second inlet of the humidifier 114, a water purifier, the electrolyzer stack 102, the fuel cell stack 112, a heat exchanger (e.g., a condenser), and/or to another process requiring water. Alternatively, the excess water vapor may be vented to the environment. In a preferred embodiment, the first outlet may be fluidly connected to a heat exchanger that is also fluidly connected to the fuel cell stack 112, thereby using the heat generated by the fuel cell stack 112 to provide heated water to various applications.

The system may further comprise an energy storage mechanism or a plurality of energy storage mechanisms. The energy storage mechanism may comprise any mechanism or apparatus operable to store energy such as electricity, thermal energy, etc. For example, the energy storage mechanism may include batteries (e.g., lead-acid batteries, lithium ion batteries, lithium iron batteries, etc.), ice, water, flywheels, compressed air, pumped hydroelectric, or other energy storage mechanisms known in the art and combinations thereof.

The system may further comprise a blower 115 or a fan. The blower or fan is operable to provide air to the humidifier 114. Thus, the blower 115 may be fluidly connectable to the humidifier 114.

The system may further utilize thermal integration to further reduce emissions. Such systems comprise a heat exchanger or a plurality of heat exchangers thermally connected to one or more system components described above. Additionally, the heat exchanger or plurality of heat exchangers may be thermally connected to one or more heating loads or cooling loads. For example, the heat exchanger(s) may be used to transfer heat generated by the fuel cell stack, the electrolyzer stack, the hydrogen recirculation stack(s), the complex molecule stack, the dryer, and/or the power electronics to a heating load. The system may further comprise a heat source or a cooling source to provide heating or cooling.

The heat exchanger or plurality of heat exchangers may comprise any heat exchanger known in the art. For example, the heat exchanger or plurality of heat exchangers may comprise a shell and tube heat exchanger, a double tube heat exchanger, a tube-in-tube heat exchanger, a plate heat exchanger, a plate and shell heat exchanger, an adiabatic wheel heat exchanger, a plate fin heat exchanger, a finned tube heat exchanger, a pillow plate heat exchanger, and combinations thereof. The heat exchanger may accomplish heat exchange through condensation of a substance to remove latent heat from the system.

The heat exchanger or plurality of heat exchangers comprises a heat exchange fluid. The heat exchange fluid may comprise air, water, steam, a mixture of water and glycol, a silicon fluid, a molten salt, or other fluids known in the art useful for heat exchange.

The heat exchanger or plurality of heat exchangers may be operable to remove the maximum amount of heat possible from the system. Although this may reduce the overall efficiency of the system, this would reduce the venting of waste heat to the atmosphere and therefore prevent further contribution to climate change. Additionally, this may be useful to reduce the heat signature of the system in circumstances where security and/or secrecy of the system is required.

The heat source may comprise resistive heating. The resistive heating may be provided by electricity produced from the fuel cell stack. Systems and methods that are capable of producing and providing resistive heating are well known and described in the art.

The heat source may additionally or alternatively comprise catalytic combustion of hydrogen produced by the system of the present disclosure. The hydrogen for catalytic combustion may be provided from the hydrogen storage system or may be provided directly from the electrolyzer. Systems and methods for catalytic combustion of hydrogen are well known and described in the art.

The heat source may additionally or alternatively comprise electrical heat pumping. The electrical heat pumping may utilize electricity provided by a direct bypass of one or more energy inputs to the system or the electricity may be provided by the fuel cell stack via the power electronics.

The heat source may additionally or alternatively comprise a geothermal heat source. Systems and methods to provide heat from a geothermal heat source are well known and described in the art.

The heat source may additionally or alternatively be provided by heat exchange with exhaust air streams utilizing condensing heat exchange.

The cooling source may comprise a heat pump or a refrigeration unit. The energy to accomplish these cooling methods may be provided by direct bypass from the energy inputs or by using electricity produced by the fuel cell stack via the power electronics. As such, the fuel cell stack may be electrically connected to a heat pump or a refrigeration system, and/or the energy inputs may be electrically connected to a heat pump or refrigeration system. The heat pump or refrigeration unit may be used in parallel with another heat exchanger in the system.

The cooling source may comprise an absorption chiller. Absorption chillers and methods of making and procuring absorption chillers are generally well known in the art. Absorption chillers are particularly suitable for use in the present system because the refrigerants used in absorption chillers (e.g., ammonia, lithium bromide, etc.) do not contribute to global warming. The absorption chiller may be thermally connected to the heat exchanger, the electrolyzer stack, the hydrogen recirculation stack(s), and/or the power electronics.

The cooling source may also or alternatively comprise a geothermal cooling source. Systems and methods for providing cooling via a geothermal source are well known and described in the art.

Heating and/or cooling may also be provided by a combination of the above heating and cooling systems and methods. For example, a heat pump may be used to increase the quality of waste heat from the fuel cell stack, electrolyzer stack, hydrogen recirculation stack(s), and/or the power electronics, and then the improved waste heat may be cooled by an absorption chiller.

Heating loads may comprise any process, system, or apparatus requiring heat. Cooling loads may comprise any process, system, or apparatus requiring removal of heat. Examples of heating and cooling loads include a dryer, a water source (e.g., a potable water source or a swimming pool), air used for forced air circulation in HVAC systems, etc.

In some embodiments, the system of the present disclosure may be integrated within a hyperbaric chamber to ensure safety for users with continuous uninterruptable power. In this arrangement, the system may also comprise sources of compression via hydrogen, oxygen, air, or combinations thereof. Stated another way, all system components may be located within a hyperbaric chamber. The hyperbaric chamber may be modular such that the chamber and the system housed therein may be readily connected to or disconnected from other processes and systems.

The system may further comprise a controller. The controller may be operably connected to one or more of the system components described hereinabove. The controller is operable to adjust various parameters of the system and the components of the system based on various inputs received, such as temperature, flow rate, pressure, current, etc. The controller may also be operable to turn one or more system components off and on.

Further provided herein is a method for generating and storing energy. The method may generally be performed by any of the systems described herein. The method generally comprises producing hydrogen in an electrolyzer stack; combining the hydrogen with oxygen in a fuel cell stack, resulting in water vapor and uncombined hydrogen; and purifying the uncombined hydrogen via a hydrogen recirculation stack(s). The hydrogen generated by the electrolyzer may be wet hydrogen.

The electrolyzer stack may comprise a membrane electrolyte.

The method may further comprise drying the hydrogen generated in the electrolyzer stack. In some examples, the drying may be accomplished via a pressure swing adsorber.

The method may further comprise storing the hydrogen in a hydrogen storage system. The hydrogen may be stored for a short time period, such as for use in providing an intermittent source of power. In such embodiments, the electrolyzer stack may be electrically connectable to an intermittent energy input. Alternatively or additionally, the hydrogen may be stored for a long time period (e.g., for providing a source of energy in the event of a power outage).

The method may further comprise removing heat from one or more of the electrolyzer stack, the fuel cell stack, and/or the hydrogen recirculation stack(s) via one or more heat exchangers. The heat removed via the one or more heat exchangers may be provided to one or more heating loads.

Further provided herein is a method for generating and storing energy. The method may generally be performed by any of the systems described herein. The method generally comprises producing hydrogen in an electrolyzer stack; combining a first portion of the hydrogen with oxygen in a fuel cell stack, resulting in water vapor and uncombined hydrogen; combining a second portion of the hydrogen with a complex molecule precursor in a complex molecule stack, resulting in uncombined hydrogen and a complex molecule; and purifying the uncombined hydrogen via a hydrogen recirculation stack. The hydrogen generated by the electrolyzer may be wet hydrogen.

The complex molecule precursor may include any complex molecule precursor described herein. In exemplary embodiments, the complex molecule precursor may comprise nitrogen or carbon dioxide. The complex molecule may comprise any complex molecule described herein. In exemplary embodiments, the complex molecule may comprise ammonia or methanol.

The electrolyzer stack may comprise a membrane electrolyte.

The method may further comprise drying the hydrogen generated in the electrolyzer stack. In some examples, the drying may be accomplished via a pressure swing adsorber.

The method may further comprise storing the hydrogen in a hydrogen storage system. The hydrogen may be stored for a short time period, such as for use in providing an intermittent source of power. In such embodiments, the electrolyzer stack may be electrically connectable to an intermittent energy input. Alternatively or additionally, the hydrogen may be stored for a long time period (e.g., for providing a source of energy in the event of a power outage).

The method may further comprise removing heat from one or more of the electrolyzer stack, the fuel cell stack, and/or the hydrogen recirculation stack via one or more heat exchangers. The heat removed via the one or more heat exchangers may be provided to one or more heating loads.

### Exemplary Embodiments

Embodiment 1: A system for generating and storing energy comprising: an electrolyzer stack for generating hydrogen; a fuel cell stack operably connected to the electrolyzer stack for converting the generated hydrogen into electricity; and a hydrogen recirculation stack operably connected to the fuel cell stack and the electrolyzer stack.

Embodiment 2: The system of embodiment 1, wherein the hydrogen recirculation stack comprises an electrochemical hydrogen pump.

Embodiment 3: The system of embodiment 2, wherein the electrochemical hydrogen pump comprises a membrane electrolyte.

Embodiment 4: The system of any one of embodiments 1-3, wherein the hydrogen utilization of the system is about 95% or greater.

Embodiment 5: The system of any one of embodiments 1-4, wherein the electrolyzer stack comprises a membrane electrolyte.

Embodiment 6: The system of embodiment 5, wherein the membrane electrolyte comprises a proton exchange membrane.

Embodiment 7: The system of embodiment 6, wherein the proton exchange membrane comprises sulfonated poly(ether ether ketone) (sPEEK), sulfonated phenylated poly(phenylene) (sPPP), sulfonated polyether (sulfone) (SPES), sulfonated polystyrene-b-poly(ethylene-r-butylene-b-polystrene (S-SEBS), or a combination thereof.

Embodiment 8: The system of embodiment 6 or embodiment 7, sulfonated tetrafluoroethylene-based fluoropolymer-copolymer having a formula C₇HF₁₃O₅S·C₂F₄.

Embodiment 9: The system of any one of embodiments 5-8, wherein the membrane electrolyte comprises an anion exchange membrane.

Embodiment 10: The system of embodiment 9, wherein the anion exchange membrane comprises imidazolium functionalized styrene polymers including cross-linked polystyrene (e.g., polystyrene crosslinked with divinylbenzene), sodium polystyrene sulfonate, PolyAMPS, polyAPTAC, polysulfone and derivatives thereof, polymers with quaternary phosphonium groups, polymers with anion exchange groups incorporated into the polymeric backbone, or a combination thereof.

Embodiment 11: The system of any one of embodiments 1-10, wherein the hydrogen recirculation stack is fluidly connected to the electrolyzer stack.

Embodiment 12: The system of embodiment 11, wherein the hydrogen recirculation stack comprises an inlet operable to receive wet hydrogen or dry hydrogen.

Embodiment 13: The system of embodiment 11 or embodiment 14, wherein the hydrogen recirculation stack comprises an outlet operable to deliver purified hydrogen.

Embodiment 14: The system of any one of embodiments 1-13, wherein the electrolyzer stack is electrically connectable to an intermittent energy input.

Embodiment 15: The system of embodiment 14, wherein the intermittent energy input is selected from the group consisting of photovoltaics, wind, hydroelectric, or a combination thereof.

Embodiment 16: The system of any one of embodiments 1-15, wherein the fuel cell stack comprises a membrane electrolyte.

Embodiment 17: The system of embodiment 16, wherein the membrane electrolyte comprises a sulfonated tetrafluoroethylene-based fluoropolymer-copolymer having a formula C₇HF₁₃O₅S·C₂F₄.

Embodiment 18: The system of embodiment 13, wherein an outlet of the hydrogen recirculation stack is fluidly connected to an inlet of the fuel cell stack.

Embodiment 19: The system of embodiment 12, wherein the fuel cell stack comprises an outlet operable to deliver hydrogen gas to the inlet of the hydrogen recirculation stack.

Embodiment 20: The system of any one of embodiments 1-19, further comprising a venturi device fluidly connected to the hydrogen recirculation stack and to the fuel cell stack.

Embodiment 21: The system of any one of embodiments 1-20, further comprising power electronics.

Embodiment 22: The system of embodiment 21, wherein the power electronics are electrically connectable to at least one of a DC energy input, an AC energy input, or a combination thereof.

Embodiment 23: The system of embodiment 21 or embodiment 22, wherein the power electronics are electrically connectable to at least one of a DC energy load, an AC energy load, or a combination thereof.

Embodiment 24: The system of any one of embodiments 1-23, further comprising a heat exchanger operably connected to at least one of the electrolyzer stack, the fuel cell stack, and the hydrogen recirculation stack.

Embodiment 25: The system of embodiment 24, wherein the heat exchanger is operable to deliver heat from the electrolyzer stack, the fuel cell stack, and/or the hydrogen recirculation stack to a heating load.

Embodiment 26: The system of embodiment 24 or embodiment 27, wherein the heat exchanger is operably connectable to a heat source.

Embodiment 27: The system of any one of embodiments 24-26, wherein the heat exchanger is operably connectable to a cooling source.

Embodiment 28: The system of any one of embodiments 1-27, wherein the electrolyzer stack is fluidly connectable to a water source.

Embodiment 29: The system of embodiment 28, further comprising an ion exchange bed fluidly connected to the water source and the electrolyzer stack.

Embodiment 30: The system of embodiment 28, further comprising a plurality of ion exchange beds fluidly connected to the water source and the electrolyzer stack.

Embodiment 31: The system of embodiment 30, further comprising a plurality of isolation valves operable to fluidly isolate each of the plurality of ion exchange beds.

Embodiment 32: The system of any one of embodiments 1-31, further comprising a dryer to remove water vapor from the generated hydrogen.

Embodiment 33: The system of embodiment 32, wherein the dryer is selected from the group consisting of a pressure swing adsorption (PSA) system, a temperature swing adsorption (TSA) system, a hybrid PSA-TSA system, or a membrane purifier.

Embodiment 34: The system of embodiment 32 or embodiment 33, wherein the dryer comprises an inlet operable to receive wet hydrogen and an outlet operable to deliver dry hydrogen.

Embodiment 35: The system of any one of embodiments 32-34, wherein the dryer is fluidly connected to the electrolyzer stack and to the fuel cell stack.

Embodiment 36: The system of any one of embodiments 1-35, wherein one or more of the electrolyzer stack, the fuel cell stack, and the hydrogen recirculation stack is fluidly connectable to a hydrogen storage system.

Embodiment 37: The system of any one of embodiments 1-36, further comprising a humidifier fluidly connected to the fuel cell stack.

Embodiment 38: The system of any one of embodiments 1-37, further comprising a complex molecule stack fluidly connected to the electrolyzer stack.

Embodiment 39: The system of embodiment 38, wherein the complex molecule stack is capable of generating ammonia.

Embodiment 40: The system of embodiment 38, wherein the complex molecule stack is capable of generating carbon-based molecules.

Embodiment 41: The system of embodiment 40, wherein the complex molecule stack is capable of generating methanol.

Embodiment 42: A system for generating and storing energy comprising: an electrolyzer stack for generating hydrogen; a fuel cell stack operably connected to the electrolyzer stack for converting the generated hydrogen into electricity; and a plurality of hydrogen recirculation stacks operably connected to the fuel cell stack and the electrolyzer stack.

Embodiment 43: The system of embodiment 42, wherein each of the plurality of hydrogen recirculation stacks comprises an electrochemical hydrogen pump.

Embodiment 44: A method of generating and storing energy comprising: generating hydrogen in an electrolyzer stack; combining the hydrogen with oxygen in a fuel cell stack, resulting in water vapor and uncombined hydrogen; and purifying the uncombined hydrogen via a hydrogen recirculation stack.

Embodiment 45: The method of embodiment 44, further comprising drying the hydrogen generated in the electrolyzer stack.

Embodiment 46: The method of embodiment 45, wherein the drying is accomplished via a pressure swing adsorber.

Embodiment 47: The method of any one of embodiments 44-46, further comprising storing the hydrogen in a hydrogen storage system.

Embodiment 48: The method of any one of embodiments 44-4720, wherein the electrolyzer stack is electrically connectable to an intermittent energy input.

Embodiment 49: The method of any one of embodiments 44-48, wherein the electrolyzer stack comprises a membrane electrolyte.

Embodiment 50: The method of any one of embodiments 44-49, wherein the fuel cell stack comprises a membrane electrolyte.

Embodiment 51: The method of any one of embodiments 44-50, wherein the hydrogen recirculation stack comprises an electrochemical hydrogen pump.

Embodiment 52: The method of any one of embodiments 44-51, further comprising removing heat from one or more of the electrolyzer stack, the fuel cell stack, and the hydrogen recirculation stack via one or more heat exchangers.

Embodiment 53: The method of embodiment 52, wherein the heat is provided to one or more heating loads.

Embodiment 54: A method of generating and storing energy comprising: generating hydrogen in an electrolyzer stack; combining the hydrogen with oxygen in a fuel cell stack, resulting in water vapor and uncombined hydrogen; and purifying the uncombined hydrogen via a plurality of hydrogen recirculation stacks.

Embodiment 55: A method of generating and storing energy comprising: generating hydrogen in an electrolyzer stack; combining a first portion of the hydrogen with oxygen in a fuel cell stack, resulting in water vapor and uncombined hydrogen; combining a second portion of the hydrogen with a complex molecule precursor, resulting in a complex molecule and uncombined hydrogen; and purifying the uncombined hydrogen via a hydrogen recirculation stack.

Embodiment 56: The method of embodiment 55, further comprising drying the hydrogen generated in the electrolyzer stack.

Embodiment 57: The method of embodiment 56, wherein the drying is accomplished via a pressure swing adsorber.

Embodiment 58: The method of any one of embodiments 55-57, further comprising storing the hydrogen in a hydrogen storage system.

Embodiment 59: The method of any one of embodiments 55-5820, wherein the electrolyzer stack is electrically connectable to an intermittent energy input.

Embodiment 60: The method of any one of embodiments 55-59, wherein the electrolyzer stack comprises a membrane electrolyte.

Embodiment 61: The method of any one of embodiments 55-60, wherein the fuel cell stack comprises a membrane electrolyte.

Embodiment 62: The method of any one of embodiments 55-61, wherein the hydrogen recirculation stack comprises an electrochemical hydrogen pump.

Embodiment 63: The method of any one of embodiments 55-62, further comprising removing heat from one or more of the electrolyzer stack, the fuel cell stack, and the hydrogen recirculation stack via one or more heat exchangers.

Embodiment 64: The method of embodiment 63, wherein the heat is provided to one or more heating loads.

As used herein “efficiency” is generally measured by hydrogen utilization. Hydrogen utilization is defined as the amount of hydrogen required to produce a predetermined amount of electricity. As the amount of hydrogen required to produce the predetermined amount of electricity decreases, utilization increases. Systems of the prior art may have a hydrogen utilization of about 85%. Systems of the present disclosure may have a hydrogen utilization of about 95% or greater; for example, about 96% or greater, about 97% or greater, about 98% or greater, or about 99% or greater.

As used herein, “wet hydrogen” refers to hydrogen that is saturated with water. Those having ordinary skill in the art will appreciate that the amount and/or concentration of water in the wet hydrogen will depend on the temperature and pressure of the wet hydrogen.

As used herein, “dry hydrogen” refers to hydrogen that has a water content of about 10 ppm or less. For example, the dry hydrogen may have a water content of about 10 ppm, about 9 ppm, about 8 ppm, about 7 ppm, about 6 ppm, about 5 ppm, about 4 ppm, about 3 ppm, about 2 ppm, about 1 ppm, or less than about 1 ppm. Preferably, the dry hydrogen has a water content of about 5 ppm or less.

As used herein, “purified hydrogen” refers to hydrogen that is at least about 99.99% pure on a mol percent basis. In some embodiments, the purified hydrogen may be 99.999% pure on a mol percent basis. Similarly, “impure hydrogen” as used herein refers to hydrogen that has not been purified and does not meet the definition of “purified hydrogen” as set forth above.

As used herein, a “fluid” connection is a connection that allows for or facilitates the transfer of fluids including liquids and gases. Non-limiting examples of fluid connections include pipes, manifolds, ducts, valves, hoses, couplings, tubes, etc.

As used herein, an “electrical” connection is a connection that allows for or facilitates the transfer of electricity. Non-limiting examples of electrical connections include wires, cables, power lines, breakers, transformers, converters, rectifiers, switches, etc.

As used herein, a “thermal” connection is a connection that allows for or facilitates the transfer of heat from one medium to another.

As used herein, an “operable” connection includes any connection that allows for or facilitates the operation of a system unit or process. An operable connection may include an electrical connection, a thermal connection, and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionalities may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for generating and storing energy comprising:
an electrolyzer stack for generating hydrogen;
a fuel cell stack operably connected to the electrolyzer stack for converting the generated hydrogen into electricity; and
a hydrogen recirculation stack operably connected to the fuel cell stack and the electrolyzer stack.

2. The system of claim 1, wherein the hydrogen recirculation stack comprises an electrochemical hydrogen pump.

3. The system of claim 1, wherein the hydrogen utilization of the system is about 95% or greater.

4. The system of claim 1, wherein the hydrogen recirculation stack is fluidly connected to the electrolyzer stack.

5. The system of claim 1, wherein the electrolyzer stack is electrically connectable to an intermittent energy input.

6. The system of claim 1, wherein the fuel cell stack comprises a membrane electrolyte.

7. The system of claim 1, further comprising a venturi device fluidly connected to the hydrogen recirculation stack and to the fuel cell stack.

8. The system of claim 1, further comprising power electronics.

9. The system of claim 8, wherein the power electronics are electrically connectable to at least one of a DC energy input, an AC energy input, or a combination thereof.

10. The system of claim 8, wherein the power electronics are electrically connectable to at least one of a DC energy load, an AC energy load, or a combination thereof.

11. The system of claim 1, further comprising a heat exchanger operably connected to at least one of the electrolyzer stack, the fuel cell stack, and the hydrogen recirculation stack.

12. The system of claim 11, wherein the heat exchanger is operable to deliver heat from the electrolyzer stack, the fuel cell stack, and/or the hydrogen recirculation stack to a heating load.

13. The system of claim 1, wherein the electrolyzer stack is fluidly connectable to a water source.

14. The system of claim 13, further comprising an ion exchange bed fluidly connected to the water source and the electrolyzer stack.

15. The system of claim 13, further comprising a plurality of ion exchange beds fluidly connected to the water source and the electrolyzer stack.

16. The system of claim 1, further comprising a dryer fluidly connected to the electrolyzer stack to remove water vapor from the generated hydrogen.

17. The system of claim 1, wherein one or more of the electrolyzer stack, the fuel cell stack, and the hydrogen recirculation stack is fluidly connectable to a hydrogen storage system.

18. The system of claim 1, further comprising a humidifier fluidly connected to the fuel cell stack.

19. The system of claim 1, further comprising a complex molecule stack fluidly connected to the electrolyzer stack.

20. A system for generating and storing energy comprising:
an electrolyzer stack for generating hydrogen;
a fuel cell stack operably connected to the electrolyzer stack for converting the generated hydrogen into electricity; and
a plurality of hydrogen recirculation stacks operably connected to the fuel cell stack and the electrolyzer stack.

21. A method of generating and storing energy comprising:
generating hydrogen in an electrolyzer stack;
combining the hydrogen with oxygen in a fuel cell stack, resulting in water vapor and uncombined hydrogen; and
purifying the uncombined hydrogen via a hydrogen recirculation stack.
